(19) United States
(12) Patent Application Publication
(10) Pub. No.: US 2012/0093379 A1
(43) Pub. Date: Apr. 19, 2012

(54) DETECTING AND DARKENING METHOD OF OBJECTS IN GREY-ACALE RASTER IMAGES

(75) Inventors: Raoul Florent, Ville Davray (FR); Stephane Valente, Paris (FR)

(73) Assignee: KONINKLIJKE PHILIPS ELECTRONICS N.V., EINDHOVEN (NL)

(21) Appl. No.: 12/673,190

(22) PCT Filed: Aug. 12, 2008
(86) PCT No.: PCT/IB2008/053217

§ 371 Date: Feb. 12, 2010

(30) Foreign Application Priority Data
Aug. 16, 2007 (EP) 07114468.7

(51) Int. Cl. G06T 5/00

(52) U.S. Cl. 382/131

(57) ABSTRACT

Wire tips and balloon/stent markers are the main landmarks used by cardiologists for navigation and precise stent placement under X-Ray fluoroscopy surveillance. These intra-coronary devices are semi radio-opaque. In some situations, their visibility can be extremely low. The claimed may help the cardiologists by detecting the objects and darkening them on the live X-Ray image to increase their visibility. The darkening processing takes into account the image properties around the objects or detection information in order to obtain a better contrast enhancement. This technique also avoids the introduction of disturbing artefacts when the object detection fails.

The invention relates to the field of fluoroscopy imaging. In particular, the invention relates to a method for highlighting of intervention objects for fluoroscopy imaging, a relating imaging system, a program element and a computer readable medium.

In fluoroscopy imaging, wire tips and balloon/stent markers are the main landmarks used by cardiologists for navigation and precise stent placement. Because they are semi radio-opaque, the visibility of said landmarks can become quite low for several reasons. The fluoroscopy pictures may be very noisy, the tips and balloon/stent markers may be located in dark areas of the image or still in the catheter tube (i.e. in a low contrast area), or masked by the vessel trace during a shot of contrast agent. Further, the tips and balloon/stent markers may be masked by a vessel map overlaid onto the live picture by an automatic cardiac roadmapping system.

The imaging method may be used by an imaging system for Percutaneous Transluminal Coronary Angioplasty (PTCA) in catheter laboratories, to treat cardiac stenoses. A description of the basic interventional procedure in this field can be found in “Algorithmic Solutions for Live Device-to-Vessel Match”, J. Bredno, B. Martin-Leung & K. Eck, Proceedings of SPIE—Volume 5370—Medical Imaging 2004: Image Processing, J. Michael Fitzpatrick, Milan Sonka, Editors, May 2004, pp. 1486-1497: “After a catheter is inserted into the vascular system at an access site, it is advanced along large vessels to the vascular structure that requires treatment. Contrast agent is injected via the catheter and [further] x-ray equipment records an angiographic sequence that shows the vessels when filled with contrast agent. The diagnostic angiogram acquisitions can be repeated with varying imager geometries. Diagnosis and intervention planning are based on such diagnostic angiograms ( . . . ). During intervention, a flexible, partially or fully radio-opaque guidewire is advanced to the affected vascular structures (e.g. stenoses in coronaries, neurovascular aneurisms, or arterio-venous malformations). Fluoroscopic low-dose x-ray surveillance visualizes the guidewire ( . . . ) and allows for the hand-eye-coordination of the interventionalist while advancing the guidewire. When positioned, the guidewire serves as rail to deliver interventional devices (e.g. balloons for dilation and stent delivery, detachable coils for aneurysm clotting). The delivery and deployment of the interventional devices is also fluoroscopy-controlled.” In such procedures, the vessel structure itself is not visible during the intervention as it is not radio-opaque. Consequently, the navigation and precise positioning of guidewire and interventional devices may be tedious, time-consuming, and requires additional contrast agent bursts to clarify the position of the devices relative to the relevant vessels.”

In “X-ray fluoroscopy spation-temporal filtering with object detection”, Aufrichtig et al., Medical Imaging; IEEE Transactions, Volume 14, Issue 4, Dec. 1995, Pages 733-746, a spatio-temporal filtering with object detection, is described that reduces noise while minimizing motion and spatial blur. Object-likelihood images are created to use these to control spatial and recursive temporal filtering such as to reduce blurring the objects of interest.

It may be desirable to provide an augmented visibility of objects of interest in a grey scale raster image.

According to an exemplary embodiment of the present invention, a method for highlighting an object of interest in a first raster image of grey scale value pixels is provided. The method comprising the steps of selecting of the object of interest in the raster image and darkening the object of interest with a grey scale value using a predetermined darkening strength parameter. One feature of the embodiment may be to provide an operators with an augmented visibility of the objects of interest (catheters, wire guide tips, balloon/stent markers) by smoothly darkening them. Since X-Ray images are in grey levels and objects of interest are semi-opaque, a controlled darkening operation produces a natural-looking result, while not being gaze-catching. Thus, an always possible misdetection of objects may not lead to disturbing artefacts. The darkening operation can be adaptive to the presence of contrast agent or local image characteristics.

According to an other exemplary embodiment of the present invention, a method for highlighting an object of interest in a first raster image of grey scale value pixels is provided. The method comprises the steps: detecting of the object of interest in the raster image, obtaining a darkening grey scale value, and darkening the object of interest with the darkening grey scale value.

In one embodiment of the invention a plurality of different or equal darkening grey scale values are obtained and used for darkening a plurality of object pixels or all object pixels of the detected objects.

According to yet another embodiment of the present invention, the darkening grey scale value is obtained from a predetermined darkening strength parameter.

According to yet another embodiment of the present invention, the method further comprises the step of obtaining detection information from said detecting of the object of interest in the raster image. On top of producing a mask image of the detected pixels, the detection process might also produces detection information such as a confidence map that contains, for every detected pixel, a value indicating how confident the detection algorithm is of being correct. The detection process often consists in thresholding an enhanced image where the enhancement value can directly be used to qualify the detection information, e.g. the degree of detection confidence.

According to yet another embodiment of the present invention, the detection information is configured as one of the group consisting of data of localisation, data of topology, data of local or global confident measurement.

According to yet another embodiment of the present invention, the grey scale value is obtained from the obtained detection information.

According to yet another embodiment of the present invention, the grey scale value is weighted by the detection information.

According to yet another embodiment of the present invention, the darkening grey scale value is obtained from a predetermined darkening strength parameter and the detection information.

According to another embodiment of the present invention, an imaging system for examination of an object of interest, the imaging system comprises a detector unit, adapted to detect the object of interest in a raster image and a picture composer, adapted to darken the object of interest with a grey scale value using a predetermined darkening strength parameter. The imaging system may be implemented into automatic cardiac road mapping systems or used for any fluoroscopy application.

Further, the image system may comprise a processor unit, adapted to determine the darkening strength parameter. In addition or instead, the system may comprise a local image analyser or/and a contrast agent monitoring device.

According to another embodiment of the present invention, a computer-readable medium, in which a computer program for highlighting an object of interest is stored which, when being executed by a processor, is adapted to carry out the steps of detecting of the object of interest in the raster image, determining a darkening strength parameter for the object of interest, and darkening the object of interest with a grey scale value using the determined darkening strength parameter.

According to yet another embodiment of the present invention, a program element for highlighting an object of interest is provided, which, when being executed by a processor, is adapted to carry out the steps of detecting of the object of interest in the raster image, determining a darkening strength parameter for the object of interest and darkening the object of interest with a grey scale value using the determined darkening strength parameter.

One aspect of the embodiment may be that the method further comprises the step of generating object pixel data of the detected object in an object mask image.

Another aspect of the embodiment may be that the method further comprises the steps of monitoring object-surrounding presence and/or concentration of contrast agent and determining the darkening strength parameter using the monitored presence and/or concentration values of contrast agent.

Yet another aspect may be that the method further comprises the steps of acquiring object-surrounding local image area properties, and analysing the acquired local image area properties, determining the darkening strength parameter using the acquired image area properties.

In yet another embodiment the local image area properties include the mean grey scale value, determined from grey scale values of a plurality of object surrounding pixel, and/or the mean contrast value of a plurality of object surrounding pixel.

In yet another aspect the darkening strength parameter is used globally for the darkening of the object of interest.

In another aspect a plurality of different grey scale values using the predetermined darkening strength is used for the darkening of the object of interest.

Yet another aspect of the method may be that the method further comprises the steps of composing a final picture, using the first raster image, the determined darkening strength parameter and the generated object mask image.

In another aspect of the method the object of interest is an artificial device used for intra-coronary surveillance, precisely, the object of interest is configured as one of the group consisting of a catheter, a wire guide tip, a balloon marker and a stent marker.

Apart from the said aspects and embodiments, several other embodiments can be foreseen. A local image analyzer and a contrast agent monitor are both optional devices of the imaging system . In a simpler embodiment, the system may just comprise an object detector and a picture composer.

The object detection and mask composition can be carried out simultaneous, and not only sequential in another aspect. Further the presence of object masks/maps are not mandatory, a composer device of the imaging system could take as input any data representing the location and/or appearance of particular objects, like chained lists of pixels, splines, coordinates of markers, to darken/highlighting the objects accordingly. Further, different darkening algorithms can be used.

These and other aspects of the present invention will become apparent from and elucidated with reference to the embodiments described hereinafter.

Exemplary embodiments of the present invention will be described in the following, with reference to the following drawings.

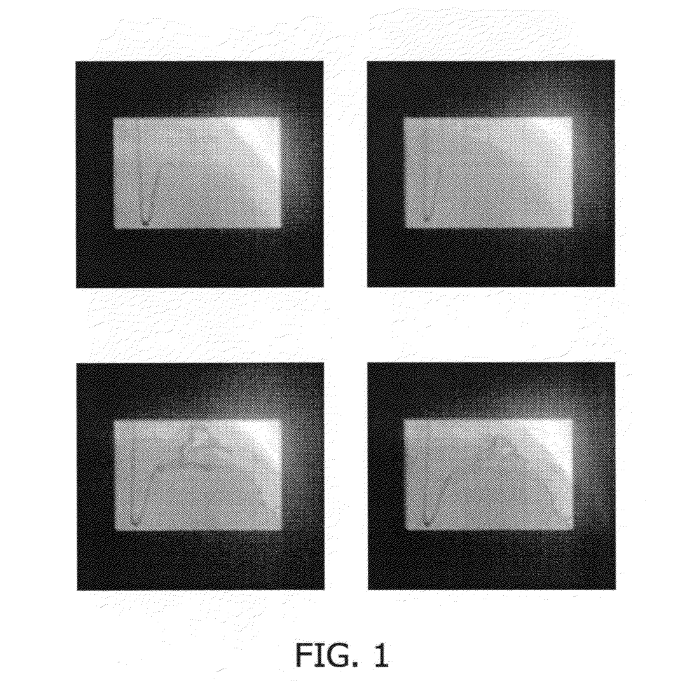

FIG. 1 shows four cardiologic grey scale X-ray images of a patient with a visible wire tip in a catheter tube.

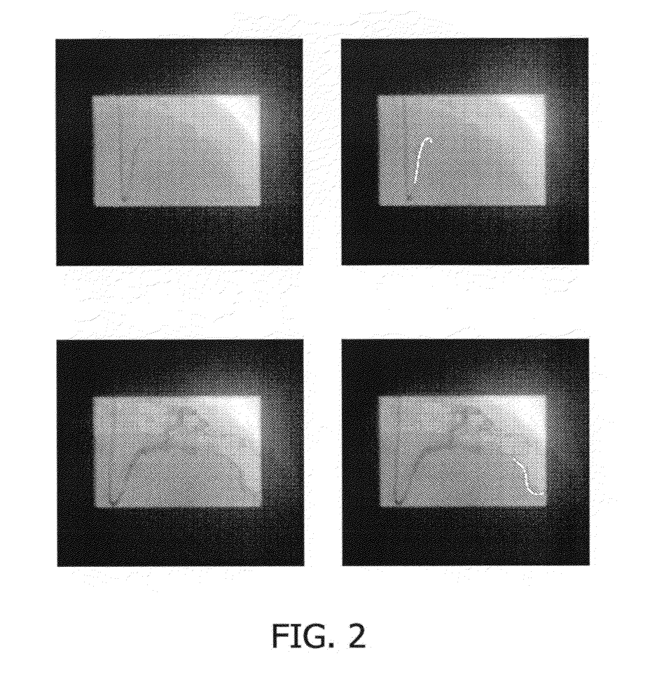

FIG. 2 shows four cardiologic grey scale X-ray images of a patient, wherein the a visible wire tip is overlaid in white.

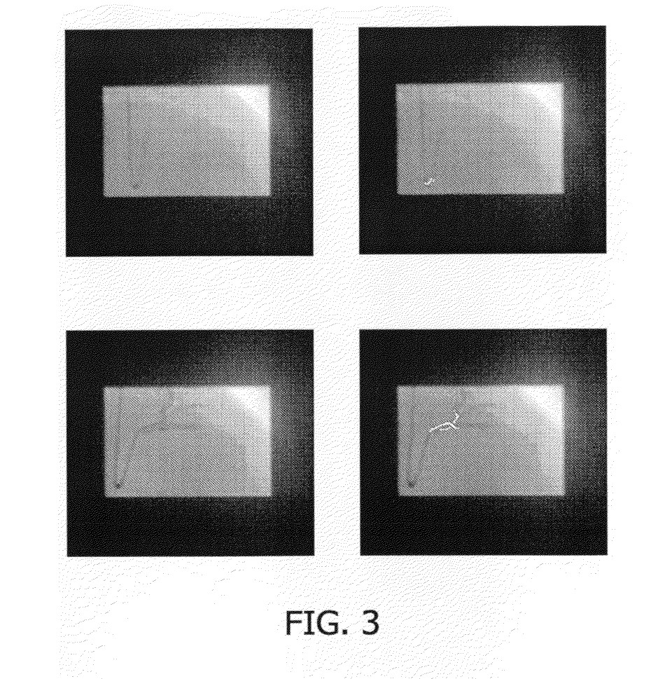

FIG. 3 shows four cardio logic grey scale X-ray images of a patient wherein the tip is not correctly segmented.

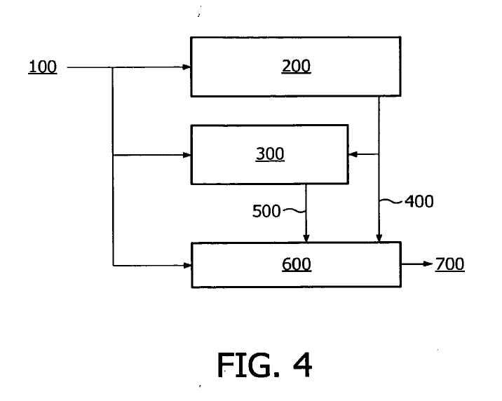

FIG. 4 shows a schematically diagram of one embodiment of the claimed imaging method

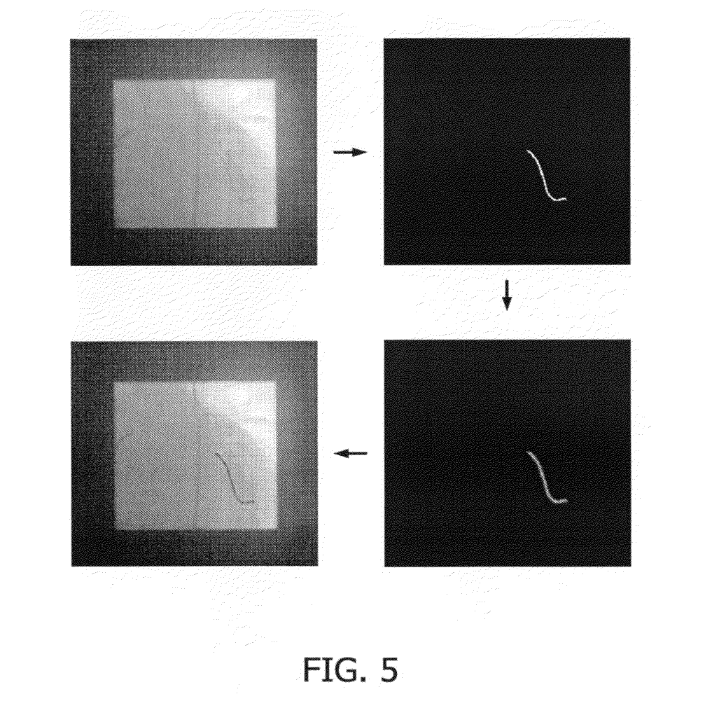

FIG. 5 shows four images in different status according to one embodiment of the imaging method.

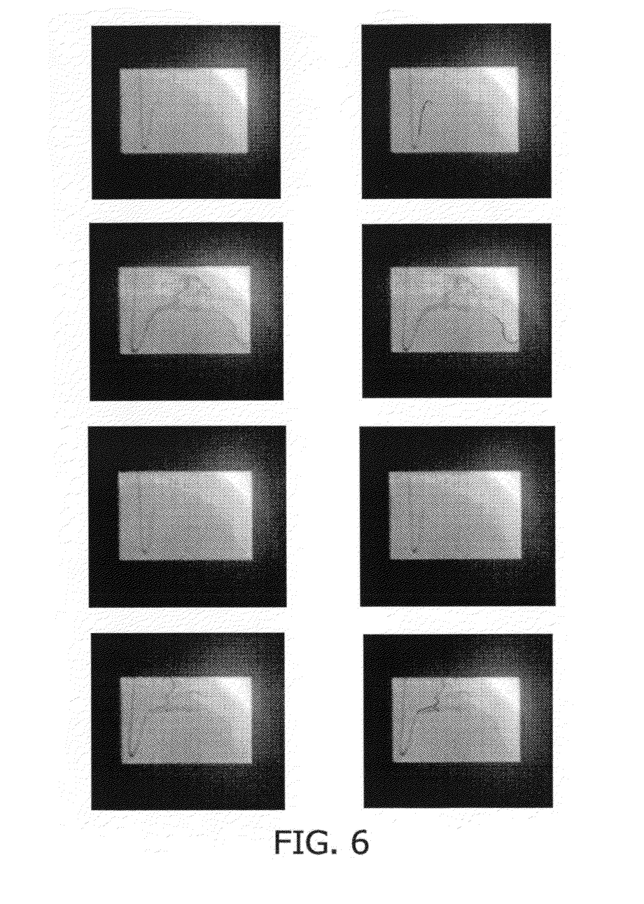

FIG. 6 shows eight images according to an overlay scheme. The left column shows different grey scale X-ray live images, the right column shows the said live images after darkening of an object of interest.

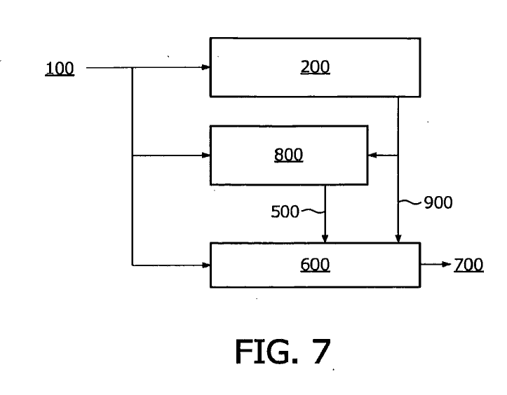

FIG. 7 shows another schematically diagram of one embodiment of the claimed imaging method.

The illustration in the drawings is schematically. In different drawings, similar or identical elements are provided with the same reference numerals.

Four different cardiologic grey scale X-ray live images of a patient with a visible wire tip in a catheter tube are shown in FIG. 1. In the shown examples the visibility of the wire tip could obviously be improved. The first row shows the tip in the catheter tube on the right side of each image, the last one shows the tip during a shot of contrast agent.

The shown low visibility problem may result in longer visual accommodation time for the cardiologists, requiring longer X-Ray expositions. Therefore the radiation absorbed by patients and operators may increase unnecessarily.

One solution could consist in using coloured overlays on the live X-Ray image to highlight the objects of interest, as shown in the next four images of FIG. 2 where the tip is overlaid in white on the right column. The shown solution can be pretty effective to help the physician locate the objects of interest. However, it suffers from two limitations. Firstly, it does not look natural or familiar to the cardiologists. Secondly, and more importantly, it turns out to be visually tiring if the object detection is not stable enough and/or produces many artefacts that flicker in the picture and unnecessarily catch the attention of operators.

This is particularly apparent on FIG. 3, where the tip is not correctly segmented.

The live images from the left each shows a wire tip, which is on the right highlighted by a white overlay. Here, the first row is a false alarm, the second one a bad segmentation. Thus, the segmented portion of the images on the left may not be consistent from one frame to the other in the image video sequence. It is therefore highly desirable to be able to increase the visibility of opaque objects of interest such as wire tips in a more natural manner that may also limits the annoyance of object misdetections.

FIG. 4 shows a diagram according to one embodiment of an imaging method. The imaging method may apply the following steps. The objects of interest in a live raster image 100 of grey scale value pixels are detected from a detector unit, here a intra-coronary devices detector 200. Their location is indicated by an object pixel map 400. The local picture properties around the object of interest, e.g. a tip, are analyzed by an analyser 300 , taking the current original image 100 and the object map 400 as inputs. The output is the darkening strength parameter(s) 500. Lastly, an image composer 600 processes the object map 400 and uses it to darken the objects in the original picture 100 with the required strength. The object detection, the analysis of image properties, the composition of an image and the darkening process are described in more detail in the next paragraphs.

### Object Detection

For the purpose of object detection, techniques such as multiscale enhancement of dark objects and thresholding as described in “Multiscale Vessel Enhancement and Filtering”, A. Frangi et al., Lecture Notes Computer Science, vol. 1496, pp 130-137, 1998, can be used. The live picture 100 is fed into an object detector 200, which produces a map (or a mask) image 400 for each type of object (catheter, wire guide tip, balloon/stent markers), where pixels indicate the presence or absence of the considered object. For instance, FIG. 5, first row, shows a live fluoroscopy image on the left, along with the corresponding mask for the tip object (right).

### Analysis of Image Properties

The object mask is fed into the local image analyzer 300 which computes the properties of the pixels in the neighbourhood of the object of interest/tip. Such properties may include the local mean luminance or the local contrast measured at the tip, to better adapt the darkening operation to the human visual system. The analyser 300 determines the strength of the darkening operation for the picture composer 600, which can be in the form of a single parameter applied globally for the darkening of the tip pixels, or a strength pixel map representing parameters applied individually to each of the pixels under the tip and its neighbourhood.

Picture composer/Darkening of objects

Several algorithms are possible to darken the pixels under the tip mask in the picture composer 600. Here, only one is described according to FIG. 5.

The tip mask shown in the upper right of an live image which is shown in the upper left of FIG. 5 is Gaussian-filtered, to obtain a smooth image of the tip shape, shown in the lower right. The Gaussian filter has been applied to the image in order to define the darkening grey scale value/darkening for each pixel. Already this embodiment shows that that darkening might depend not from a local analysis of the image. The said smoothed tip image is subtracted to the original picture to obtain a final image (FIG. 4, 700) shown in the lower left of FIG. 5. In fact the darkening grey scale values might be computed from detection information (localisation, topology, confidence measurement, . . . ) and/or local (in the vicinity of the detected objects) or global measurements in the image.

FIG. 6 shows some examples of the described overlay scheme. The right image column are live images before the overlay, the left column shows the images with darkened tips.

It can be seen in the last two rows of FIG. 6 that object misdetections are not as disturbing as with white overlays, shown in FIG. 3.

In a second simpler embodiment, shown in FIG. 7, the darkening of the object of interest can be made globally adaptive to contrast agent shots in vessels instead of being locally adaptive to image properties. The local image analyzer is replaced by a block 800 that monitors the presence and/or amount of contrast agent in the vessels. It can determine the proper strength of the darkening operation performed on the tip object to make up for the darkening of the vessels. The objects of interest in a live raster image 100 of grey scale value pixels are detected from a detector unit, here as in FIG. 4 a intra-coronary devices detector 200. The location of the object pixels is indicated by an object pixel mask 900. Device 800 monitors the presence and/or amount of contrast agent in the vessels, and takes the current original image 100 and the object mask 900 as inputs. The output is the darkening strength parameter(s) 500. Lastly, an image composer 600 processes the object mask 900 and uses it to darken the objects in the original picture 100 with the required strength in the final composition image 700.

It should be noted that the term “comprising” does not exclude other elements or steps and the “a” or “an” does not exclude a plurality. Also elements described in association with different embodiments may be combined.

It should also be noted that reference signs in the claims shall not be construed as limiting the scope of the claims.

1. A method for highlighting an object of interest in a first raster image of grey scale value pixels, the method comprising the steps:
detecting of the object of interest in the raster image;
obtaining a darkening grey scale value;
darkening the object of interest with the darkening grey scale value

2. The method according to claim 1, wherein the darkening grey scale value is obtained from a predetermined darkening strength parameter.

3. The method according to claim 1, the method further comprising the step:
obtaining detection information from said detecting of the object of interest in the raster image.

4. The method according to claim 3, wherein the detection information is configured as one of the group consisting of data of localisation, data of topology, data of local or global confident measurement.

5. The method according to claim 3, wherein the grey scale value is obtained from the obtained detection information.

6. The method according to claim 3, wherein the grey scale value is weighted by the detection information.

7. The method according to claim 3, wherein the darkening grey scale value is obtained from a predetermined darkening strength parameter and the detection information.

8. The method according to claim 1, the method further comprising:
generating object pixel data of the detected object in an object mask image.

9. The method according to claim 1, the method further comprising:
monitoring object-surrounding presence and/or concentration of contrast agent;
determining the darkening strength parameter using the monitored presence and/or concentration values of contrast agent.

10. The method according to claim 1, the method further comprising:
acquiring object-surrounding local image area properties;
analysing the acquired local image area properties;
determining the darkening strength parameter using the acquired image area properties.

11. The method according to claim 10, wherein the local image area properties include
the mean grey scale value, determined from grey scale values of a plurality of object surrounding pixel; and/or
the mean contrast value of a plurality of object surrounding pixel.

12. The method according to claim 1, wherein the darkening strength parameter is used globally for the darkening of the object of interest.

13. The method according to claim 1, wherein a plurality of different grey scale values using the predetermined darkening strength is used for the darkening of the object of interest.

14. The method according to claim 1, the method further comprising:
composing a final picture, using the first raster image, the determined darkening strength parameter and the generated object mask image.

15. The method according to claim 1, wherein the object of interest is an artificial device used for intra-coronary surveillance.

16. The method according to claim to claim 1, wherein the object of interest is configured as one of the group consisting of a catheter, a wire guide tip, a balloon marker and a stent marker.

17. An imaging system for examination of an object of interest, the imaging system comprising:
a detector unit, adapted to detect the object of interest in a raster image;
a picture composer, adapted to darken the object of interest with a grey scale value.

18. The imaging system of claim 17, further comprising a processor unit, adapted to determine a darkening strength parameter.

19. A computer-readable medium, in which a computer program of examination of an object of interest is stored which, when being executed by a processor, is adapted to carry out the steps of:
detecting of the object of interest in the raster image;
obtaining a darkening grey scale value;
darkening the object of interest with the darkening grey scale value.

20. A program element of examination of an object of interest, which, when being executed by a processor, is adapted to carry out the steps of:
detecting of the object of interest in the raster image;
obtaining a darkening grey scale value;
darkening the object of interest with the darkening grey scale value.
